(19) United States
(12) Patent Application Publication
(10) Pub. No.: US 2013/0208391 A1
(43) Pub. Date: Aug. 15, 2013

(54) Spiral Pulse Transducer

(71) Applicant: Richard Henry Lee, San Juan Capistrano, CA (US)

(72) Inventor: Richard Henry Lee, San Juan Capistrano, CA (US)

(21) Appl. No.: 13/372,769

(22) Filed: Feb. 14, 2012

(51) Int. Cl. H01T 23/00

(52) U.S. Cl. 361/230

(57) ABSTRACT

The spiral pulse transducer generates or transduces pulses by directing an electrical pulse around an electrically conducting ring. An effective way to do this is to direct it inwardly along a spiral, which can generally intensify the pulse and make it more unidirectional. While a principal embodiment is intended to help reduce blood pressure, this transducer might be used for medical, commercial, agricultural, or industrial processes.

### CROSS REFERENCE TO RELATED APPLICATIONS

This invention utilizes concepts presented in my U.S. Pat. No. 6,013,021 in that it can be utilized to produce pulses in the electromagnetic field of the human body to enhance this field and improve health, wellbeing, and quality of life. It might also utilize the unpredictable signals of my previous patents U.S. Pat. No. 6,461,316, U.S. Pat. No. 6,770,042 and U.S. Pat. No. 7,419,474 for therapy and to reduce traumatic programming in the body. However this invention is intended not to be limited to these prior applications.

### BACKGROUND OF INVENTION

1. Field of Invention

This invention relates to spiral pulse transducers, devices that receive electrical signals and convert these signals to a rotational form of energy.

2. Background of Invention

The literature reveals several devices which utilize a spiral coil with an inwardly spiraling electrical impulse. The applications are generally voltage transformers and spark generators such as US 2009/0091259A1 which shows a spiral coil for igniting a high intensity discharge lamp. High intensity igniters produce an electrical discharge from a wire at the center of a spiral to ionize a gas so as to start the electrical discharge in a mercury vapor or halogen lamp. The basis for these step-up transformers is shown in U.S. Pat. No. 3,289,015, which describes two concentric spirals, both of which are charged electrically to the same voltage. One is then grounded, and as it discharges, a very high voltage is generated between the inner ends of two spiral conductors. Some antennas have a spiral design such as U.S. Pat. No. Pat. 4,630,064, which shows several spirals used to send and receive electromagnetic pulses. Broadcast antenna utilize a variety of spirals in a variety of ways. One patent, U.S. Pat. No. 7,692,603, filed Jul. 9, 2008 discloses a drawing which appears somewhat similar to the current invention in that it utilizes spiral conductors to broadcast electromagnetic signals. FIG. 3, element 320c of that patent shows four partial circular conductors referred to as “non coiled center conductor portions”. FIG. 20 of that patent shows what appears to be an electrically conductive disc inside a spiral antenna, connected electrically to the spirals by electrically conductive radial arms. References 2030 and 2130 refer to a uniform gap or non-uniform gap between arms, so the round central disc is not described as electrically conducting and no purpose is ascribed to it. The current invention imparts a tangential pulse, not a radial pulse, to the central disc, differentiating it from the prior art which shows radial conducting arms connecting to a disc.

### SUMMARY

This invention involves directing an electrical pulse train tangentially into a circular conductive pathway for applications in medicine and technology. More specifically, in one embodiment, it induces a train of pulses into a human body for therapy, or into other substances that respond to the tangentially flowing pulses in the circular conducting pathway.

### SUMMARY OF THE INVENTION WITH OBJECTS

A first object of this invention is to create a relatively high voltage, low current pulse with a fast rise time. This is achieved by a boost circuit with a tiny, high frequency inductor. A second object is to transduce the pulses of this pulse train by means of an electrically conducting spiral and electrically conducting disc. A third object is to provide an electrical pathway whereby the ring receives pulses without reflection whereby they flow in a unidirectional rotation around the disc. A fourth object is to provide an electrically conductive pathway at the inner end of a conductive spiral around which an electrostatic impulse can continue to rotate after it has reached the center of the spiral. A fifth object is to create an electrostatic pulse with high voltage and little or no electron flow. A positive pulse appears to work better than a negative pulse, and as the pulse travels inward through the spiral its intensity goes up as the current goes down. A sixth object is to excite, stimulate, or soothe a person by applying such a pulse into their body. A seventh object is to apply this pulse to a substance such as a crystal, a mineral, or other substance to further transduce the energy of the pulse. An eighth object is to provide a simple, inexpensive low power means of applying a series of pulses to a human body for effective therapy.

### BRIEF DESCRIPTION OF THE DRAWINGS

FIG. 1 shows a basic circuit including a pulse generator feeding pulses tangentially around a conducting ring. FIG. 2 shows the same electronic circuit as in FIG. 1 with a perspective view of the ring as in FIG. 2, so as to show three additional features; a spiral connected between the coil of the electronic pulse generator and the ring, a crystal positioned near the ring, and an electrical conductor also positioned near the ring.

### DRAWINGS—REFERENCE NUMERALS

10 Microcontroller
20 FET Switching Transistor
30 3V Battery
40 22uH Boost Inductor
50 Straight Short Conductor
60 Electrically Conducting Ring
70 Non-Conducting Hole in Electrically Conducting Ring
80 Electrically Conducting Spiral
90 Crystal (Material) Near Ring
100 Electrostatic Charge Conductor

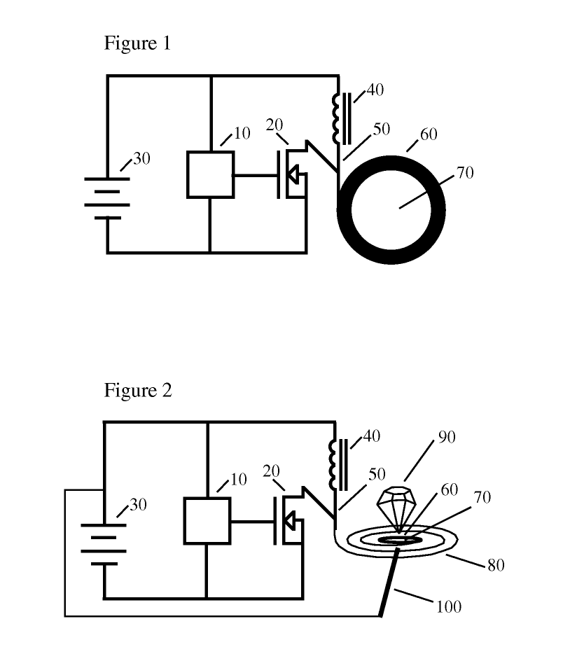

### DETAILED DESCRIPTION OF THE DRAWINGS—FIG. 1

FIG. 1 shows controller 10 which switches transistor 20 to allow current from 3 volt lithium coin cell battery 30 to flow through 22uH coil 40 which builds up a magnetic field for about 1 microsecond. Then control circuit 10 switches transistor 20 off, and the magnetic field in coil 40 collapses, producing a voltage pulse of about 70 volts. This constitutes a boost converter, a standard application familiar to those familiar with the art. This pulse is fed through generally straight short pathway 50 and tangentially into electrically conducting ring 60. Straight short pathway 50, or rather avoiding long pathways and sharps bends, is be is important to the design in that an electrostatic pulse which is an important aspect of this invention travels better without sharp turns. Such sharp bends create characteristic capacitive and inductive losses interfering with propagation of the pulses.

Note that transistor 20 connects to pathway 50 at an angle greater than 90 degrees, which impedes pulses from traveling between the transistor and the coil. This encourages pulses in the direction of the spiral and discourages pulses away from the spiral. This is because, when transistor 20 switches off, it blocks the forward surge through the transistor, creating a reverse pulse, which is in the same direction as the pulse being produced by coil 40 as its magnetic field collapses. In this way both pulses reinforce each other to propagate in the same direction around ring 60 and the pulse is discouraged from surging back to the transistor, providing greater pulse strength into the ring.

The pulse, after entering ring 60 tangentially, continues rotating around the outside of non-conducting hole 70, creating a new kind of pulse, a pulse with rotating characteristics, with its magnetic and electrostatic characteristics.

### DETAILED DESCRIPTION OF THE DRAWINGS—FIG. 2

FIG. 2 is similar to FIG. 1, except that it adds a spiral coil 80 to intensify the pulses, a substance 90 such as a crystal, to be influenced by the pulses, and an electrical conductor 100 to receive excess electrostatic charge that results from the pulse. Spiral 80 and ring 60 are drawn in perspective to show the relative positions of substance 90 and electrical conductor 100. In a preferred embodiment spiral 80 is about 0.2 inches in diameter. Spiral 80 is connected circumferentially to ring 60 which is about 0.005 inches in diameter and has hole 70, which is about 0.0025 inches in diameter. The very small size enhances the effectiveness of this embodiment at the very low current draw of this circuit, about 1 microamp at 3 volts. As the pulse spirals inward around the spiral it generates a magnetic field which couples the different turns of the spiral together. This magnetic field reduces the intensity of the pulses in the outer turns and intensifies the pulses in the inner turns. In this way, current is reduced and voltage is increased such that more of the energy of the pulse can be delivered to the ring.

Substance 90 is excited by the pulses of ring 60 and adds its own response to the pulse. Electrical conductor 100 is positioned near ring 60 behind an electrical insulator, which, in this case is the circuit board on which the spiral and ring are printed. Electrical conductor 100 can also be printed on the opposite side of the circuit board, though it might also be angled so it is not planar with spiral 80 and ring 60. Conductor 100 is important in this embodiment because it bleeds off excess static electrical charge from the pulse that might otherwise disrupt control 10 or create other problems. The excess charge can be bled to the negative side of battery 30, or fed back into the positive terminal of battery 30, as shown in FIG. 2. It might also be fed through a diode.

### DETAILED DESCRIPTION OF THE FIRST EMBODIMENT

The first embodiment of the invention is as shown in FIG. 1. A series of pulses, which might be produced at irregular intervals, are generated by a boost circuit and injected tangentially into a ring where they circulate circumferentially around the ring without reflection. This circumferential circulation of the pulses in an electrically conducting ring creates resulting pulses with magnetic and electrostatic effects, and can influence the human body and other substances. This effect is more pronounced when there is a hole in the middle of the conducting ring which is roughly half to ¾ the diameter of the ring so the pulses are guided to travel around the hole. However, the pulses still have some effect even if the ring is a disc (a ring with an infinitely small hole. The hole) which is essentially an area of significantly reduced electrical conductivity, reduces pulse reflection and causes the pulse flow to be more organized and unidirectional around the ring. It also eliminates currents that would otherwise be induced in the central area. The hole may have other effects and benefits as well, and components might be inserted in the hole, though in this embodiment, the hole has a diameter of 0.025 inches, so there is not much room.

### DETAILED DESCRIPTION OF THE SECOND EMBODIMENT

The second embodiment shown in FIG. 2, includes the first embodiment and adds a material such as a mineral or a crystal close to the central ring of the spiral. A crystal about the size of the ring seems to be most effective. The pulse excites the material to enhance the pulse effect and to change the nature of the pulse according to the radiant, optical, acoustical, or electromagnetic quality of the material. One such mineral is a quartz crystal containing iron. It is hypothesized that the rotating current around the ring creates a very strong and tiny rotating magnetic field through the hole that might either induce a voltage in the electrical nature of the crystal or induce activity in the iron, which is a highly magnetically responsive atom. This hypothesis is not intended to limit the claims of this invention in any way. In any case, the addition of a material near the ring can increase the effectiveness of the pulse in a wide variety of ways depending on the material employed. This invention might be used to stimulate metals, plastics, semiconductors, living things, or other materials.

A key to the value of this invention is its extremely low power consumption, providing an effective pulse train at a current draw of around one microamp. While this device might be applied anywhere, and more specifically, to any part of the body, one particular embodiment involves positioning the circuit like a wrist watch, except positioned over the inside of the wrist rather than the back of the wrist. In this configuration the pulses penetrate the circulatory system, calming the body and reducing blood pressure.

It was discovered that this crystal placement, particularly with a very small crystal, approximating the size of the ring (a few hundredths of an inch in diameter) causes a pulse of sufficient strength that it can interfere with the operation of microcontroller 10 which is located just a few millimeters away from the ring and crystal. To control this interference, it was discovered that a conductor located on the opposite side of the circuit board from the spiral and located directly behind the annulus can reduce this interference by reducing excess electrostatic charge. This excess charge can be fed to the ground of the circuit or fed to the high side of the circuit providing some of the power requirements of the circuit and reducing the battery requirement.

The series of electrical pulses is intended to mean abrupt changes in voltage or current, which might occur in AC or DC signals, though DC pulses are preferred. Electrical pulses might be bursts of electrons, of holes, of electrostatic charge, or any other form of electrical flow. While it is anticipated that the pulses be generally unidirectional, this circuit might combine positive and negative pulses. Tangential can mean contacting the outer surface or side of a ring, or tangential motion of a pulse near the surface of the ring as long as the direction of the pulses is generally tangential to the circumference of the ring, or to the curve of the spiral. Transducer is used in its widest definition, to indicate any device that converts energy from one form to another.

The electrical pulses might be transferred in one or more of several ways. The two embodiments above show the pulses directly coupled to the ring through an electrical conductor. It is also possible to wrap a magnetic coil around the ring to induce pulses inductively. It is further possible to wrap a coil similarly around the ring, except very close coupled so there is substantial capacitive coupling between the coil and the ring. In this way the pulse is capacitively transferred from the coil to the ring. It is interesting to note that the turns of the spiral create a magnetic field which weakens the strength of the pulse as it travels through the outer turns of the coil and strengthens it as it travels through the inner turns. This might be one way to understand how pulses traveling inward along the spiral show an increase in potential and a reduction in current.

### CONCLUSIONS RAMIFICATION AND SCOPE

The transducer of this invention is not intended to be limited by this specification. For instance, the spiral itself need not be planar, but can be conical cylindrical or parabolic in shape. It need not be constant in dimensions. While it is described here as very small, it might be much smaller, or very large. It can have varying spacing between turns, and varying size of conductors at closer distances from the center. Further, the spiral need not be symmetrical nor have the conducting ring at its exact center. The ring might be a disc, a disc with a small hole, or a ring with a relatively large hole. It can be a very flat ring like the rings of Saturn, or might be shaped more like a cylinder. It can be of rectangular cross section, or of any other cross section such as round, semi-circular or any other shape. It can be made of any material that is more electrically conductive than the medium it is in, generally air or an insulating material, though highly conductive materials like copper, silver and gold are generally the most conducive to rotating pulses, and most convenient in circuit board manufacture.

The electrical pulse can be injected tangentially by a conductor directly connected to the annulus, or might be capacitively coupled by a conductor that passes in close proximity to the disc to induce current as the pulse passes through the conductor.

While it is important that the hole be less electrically conductive than the annulus, the hole might contain a variety of materials, such as magnetically conductive strands to direct magnetic flux produced by the rotating electrical pulse around the annulus. It might also contain a wide variety of other things such as electrically conductive elements, additional spirals, conductors or resonators.

The material positioned near the ring might be any sort of material that responds to the pulse of the ring. It might be of any size, though, in the case of a crystal, it tends to be more intense as it more closely matches to the diameter of the annulus. It might be flat and it might be other shapes such as rod shaped, perhaps propagating a pulse through its body.

The resulting pulse might be utilized in a wide variety of ways, not only including exciting minerals and interfering with microprocessors. It might directly influence liquids foods or chemicals. The electrical conductor, herein described as located behind the circuit board, might be positioned anywhere in which it is able to attenuate or harness the pulse toward a wide variety of ends. It might be of any material. In addition to grounding out the excess and feeding the excess back into the battery or other power source, it might be used for such things as producing light or sound, or other medical, commercial, and industrial uses as might be discovered for it.

Also, conductor 100 that can be used to control the electrostatic pulse might be configured in a wide variety of ways. While it is shown as a straight conductor, it might be configured as a disc, ring or spiral or connected such that the electrical current flows tangentially, or perpendicular to the plane of the ring.

None of the description here is intended to limit the extent of uses for this invention or to limit the claims.

1. A transducer comprising an electrical conductor, an electrically conducting ring, and a series of electrical pulses; wherein said electrical conductor directs said pulses into said ring in a direction generally tangential to the circumference of said ring; wherein said pulses rotate circumferentially around said ring; and wherein said rotating pulses influence a substance located proximal to said ring.

2. The transducer of claim 1; wherein said ring comprises a disc.

3. The transducer of claim 1; wherein said influenced substance produces an energetic response; and wherein said energetic response of said substance influences other substances.

4. The transducer of claim 3; wherein a second electrical conductor is positioned proximal to said ring; and wherein said second electrical conductor receives an electrical charge as a result of said influence created by said pulse.

5. The transducer of claim 4; wherein said second conductor transfers said charge to an electrical power source.

6. The transducer of claim 1; wherein said ring is less than 2 inches in diameter

7. The transducer of claim 1; wherein said ring is less than 0.2 inches in diameter.

8. The transducer of claim 1; wherein said electrical conductor directs said pulses into said ring by a multiplicity of means selected from the following: induction, capacitance, and direct electrical connection to said ring.

9. The transducer of claim 1; also comprising an inductor and a transistor; wherein said conductor connects to said transistor and to said inductor; wherein said transistor abruptly stops the flow of current through said inductor; and wherein said conductor has a sharp bend greater than 90 degrees between said transistor and said inductor.

10. The transducer of claim 1; wherein said electrical conductor comprises a spiral.

11. A transducer comprising an electrically conducting spiral, an electrically conducting ring, and a series of electrical pulses; wherein said pulses are conducted inward along said spiral; wherein said pulses enter said ring tangentially to circumference of said ring; and wherein said pulses rotate circumferentially around said ring.

12. The transducer of claim 11; wherein said rotating pulses influence a substance located proximal to said ring.

13. The transducer of claim 11; wherein said spiral completes at least one complete turn before entering said disc.

14. The transducer of claim 11; wherein said pulses travel along a generally straight, short pathway to the entrance of said spiral.

15. The transducer of claim 11; wherein said ring and said spiral are coplanar.

16. The transducer of claim 11; wherein said spiral is not planar.
